(19) United States
(12) Patent Application Publication
(10) Pub. No.: US 2002/0157514 A1
(43) Pub. Date: Oct. 31, 2002

(54) Cutting mold set of metal tubes

(76) Inventor: Chi-Wen Ko, Taichung (TW)

Correspondence Address: Liberty Patent & Trademark Office, 3F-7, No. 66, Sec. 3, Pei-Ping Rd., Taichung, 406, TW

(21) Appl. No.: 09/809,615

(22) Filed: Mar. 16, 2001

(51) Int. Cl. B23D 21/00; B23D 21/02

(52) U.S. Cl. 83/181; 83/193; 83/198; 83/533; 83/618

(57) ABSTRACT

The invention relates to a cutting mold set of metal tubes, comprising of the following: a cutting mold unit that moves in relation to a lower mold unit is installed on one side of an upper mold unit, the upper mold unit is capable of moving in relation to a lower mold unit. On the cutting mold unit is installed a first mold block with a cutting hole, and on the lower mold unit is installed a second mold block with a through hole, the cutting hole and the through hole matching and communicating with each other. With the metal tube inserted inside the through hole and the cutting hole, when the upper mold unit and the cutting mold move toward the lower mold unit, the cutting hole and the through hole move in relation to each other to create a cutting force to cut the metal tube, thereby achieving the objectives of speedy and safe operation, enhancing safety in cutting operation, and reducing waste iron scraps.

### BACKGROUND OF THE INVENTION

Metal tubes are manufactured in rods measuring a length of several meters, and are cut in sections to suit actual needs. Conventionally, the metal tube is placed on a sawing bench and cut in sections by a sawing blade that turns in high speed. Though metal tubes can be obtained in specific lengths as they are needed, such a process involve drawbacks as follows:

Firstly, conventional sawing operation is slow, often taking too much time in the process. Though the sawing blade and the metal tube move speedily in relation to each other, it does involve powerful friction that produces sparks as a thread to operational safety. So the conventional sawing method is time-consuming, dangerous, and not practical.

Secondly, burrs often result on the cut openings of the metal tube in conventional cutting process. The burrs are quite sharp edges and would often cut the operators when they are moving the metal tubes. Therefore, in consideration of safety, conventional cutting method needs to be improved.

Thirdly, friction between a speedily rotating sawing blade and a metal tube will definitely produce scraps. Numerous high temperature & hot scraps involve the risk of harming the operators, who have to dispose of the waste scraps after cooling down. That becomes an additional task for the operators, which must be addressed.

### BRIEF DESCRIPTION OF THE INVENTION

In view of the above drawbacks, the inventor has provided a metal tube cutting mold set, using a first mold block with a cutting hole and a second mold block with a through hole that move in relation to each other to produce a shearing force to cut a metal tube that is inserted inside the cutting hole and the through hole, thus achieving the objectives of speedy and safe operation, upgrading safety in the cutting process, and reducing waste scraps.

### BRIEF DESCRIPTION OF DRAWINGS

The drawings of preferred embodiments of this invention are described in following details to enable better understanding.

FIG. 1 is a perspective view of the invention.

FIG. 2 is an exploded view of part of the invention.

FIG. 3 is a schematic view of the invention.

FIG. 4 is a first view of the invention in operation.

FIG. 5 is a second view of the invention in operation.

FIG. 6 is a perspective view of an embodiment of the cutting hole and through hole of the first and second mold blocks of the invention.

FIG. 7 is a plane view of another embodiment of the cutting hole and through hole of the first and second mold blocks of the invention.

FIG. 8 is FIG. 7 in operation.

FIG. 9 is a perspective view of the mold block of the invention providing oblique cutting effect.

FIG. 10 is a schematic view of the mold block of the invention providing oblique cutting effect.

FIG. 11 is another schematic view of the invention.

BRIEF DESCRIPTION OF NUMERALS

| | | | |
|---|---|---|---|
| 10 | upper mold unit | 11 | joining plate |
| 12 | extension press cylinder | 13 | extension end |
| 14 | guide lever | 15 | shaft rod |
| 16 | flexible member | 20 | cutting mold unit |
| 21 | shaft rod | 30 | lower mold unit |
| 40 | first mold block | 41 | cutting hole |
| 50 | second mold block | 51 | through hole |
| 61 | metal tube unit | 62 | guide lever |
| 63 | activating press block | 71 | tube unit |
| 81 | incline | 82 | incline |

### DETAILED DESCRIPTION OF THE INVENTION

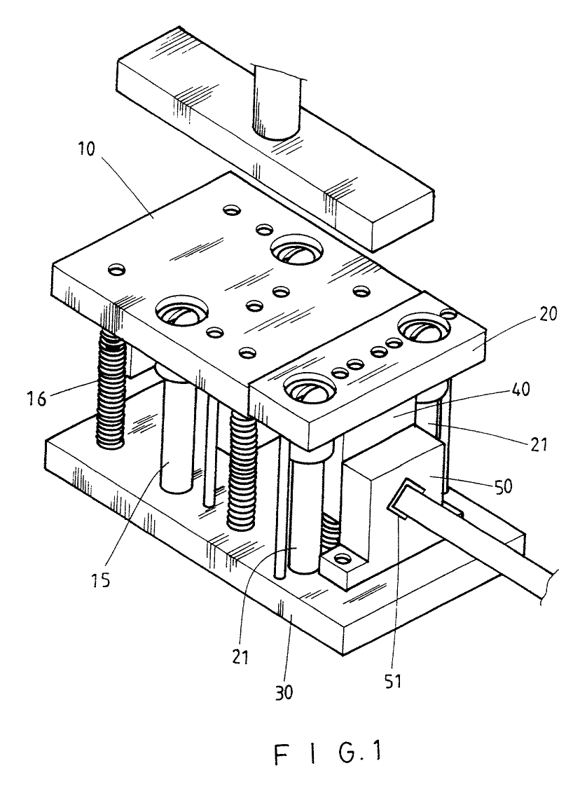

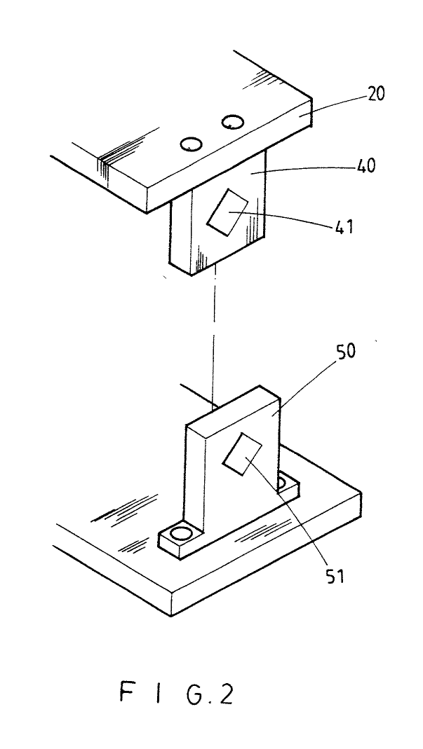

As shown in FIGS. 1, 2 and 3, this invention comprises an upper mold unit (10), a cutting mold unit (20), a lower mold unit (30), a first mold block (40) and a second mold block (50). One side of the upper mold unit (10) is fixed a joining plate (11). To the joining plate (11) is fixed an extension press cylinder (12). An extension end (13) of the extension press cylinder (12) is fixed a guide lever (14) in a specified shape. The bottom side of the upper mold unit (10) is assembled several shaft rods (15) and flexible members (16). The bottom side of the cutting mold unit (20) is assembled several shaft rods (21) and is located on the relative side to the extension press cylinder (12) that is fixed to the upper mold unit (10). One side of the lower mold unit (30) is joined to one end of the shaft rods (15), (21) and the flexible member (16) is located on the upper mold unit (10) and the cutting mold unit (20), so designed that the upper mold unit (10) can be moved in relation to the cutting mold unit (20) and the lower mold unit (30). After the upper mold unit (10), the cutting mold unit (20) and the lower mold unit (30) are assembled and joined together, the upper surface of the cutting mold unit (20) is slightly higher than the upper surface of the upper mold unit (10). On the surface of the first mold block (40) is a cutting hole (41) in a specified running through shape When necessary, the edges of the cutting hole (41) can be made as cutting edges. In the assembly, the first mold block (40) is assembled to the bottom side of the cutting mold unit (20). On the surface of the second mold block (50) is a through hole in a specified running through shape. When necessary, the edges of the through hole (51) can be made as cutting edges. In the assembly, the second mold block (50) is assembled on the lower mold unit (30), next to (or in close contact with) the first mold block (40). Making the through hole (51) with the cutting hole (41) become relatively running through shape. When the first mold block (40) and the second mold block (50) are positioned and the cutting hole (41) and the through hole (5 1) are aligned to each other, the top side of the cutting hole (41) is slightly higher than the top side of the through hole (51).

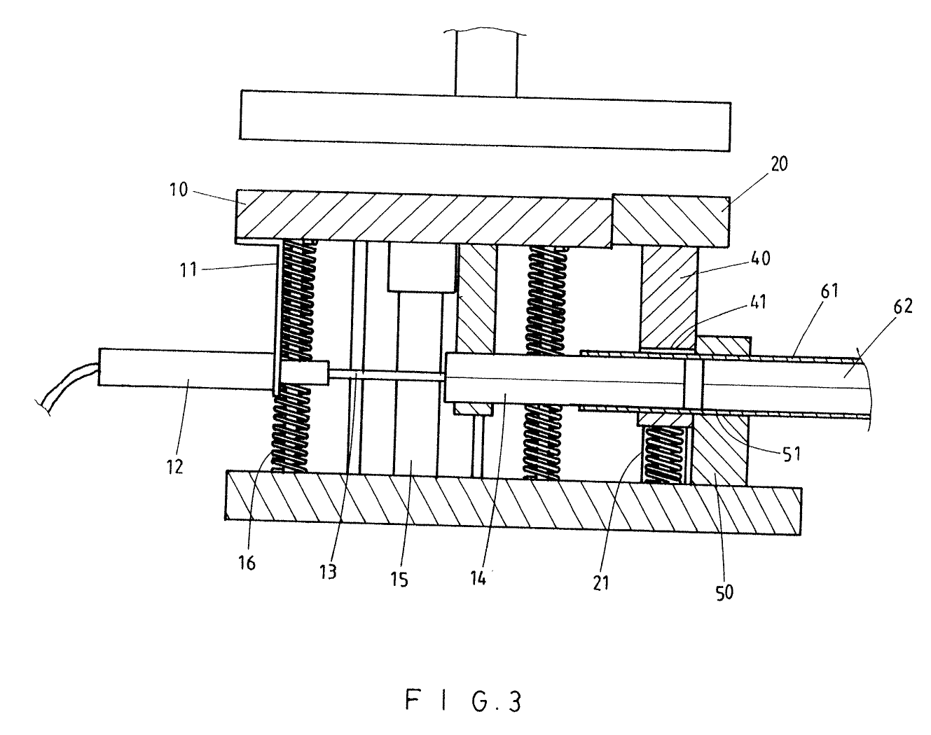

As shown in FIG. 3, this invention is operated in a way that, one end of a metal tube unit (61) is penetrated through the cutting hole (41) and the through hole (51), which are matched and aligned in precise position to each other, respectively of the first mold block (40) and the second mold block (50), while a guide lever (14) at one end of the extension cylinder (12) that is fitted to the upper mold unit (10) is inserted the metal tube unit (61), but the end is not penetrated the through hole (51), and running through the metal tube unit (61) is another guide lever (62), the end of said guide lever (62) is not penetrated the cutting hole (41), in other words, the two guide levers (14), (62) inserted inside the metal tube unit (61) are at a interval, said interval being located exactly at the contact surface between the first mold block (40) and the second mold block (50).

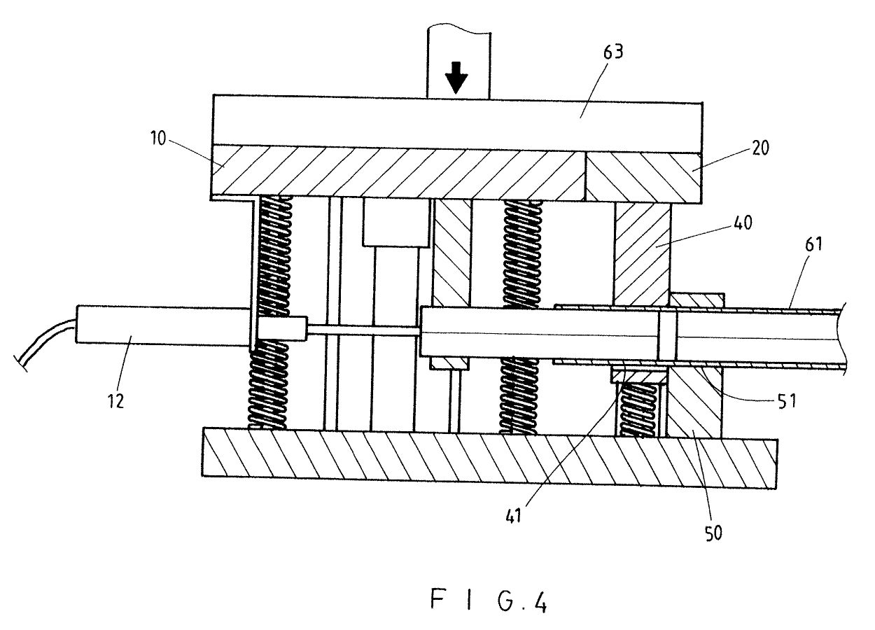

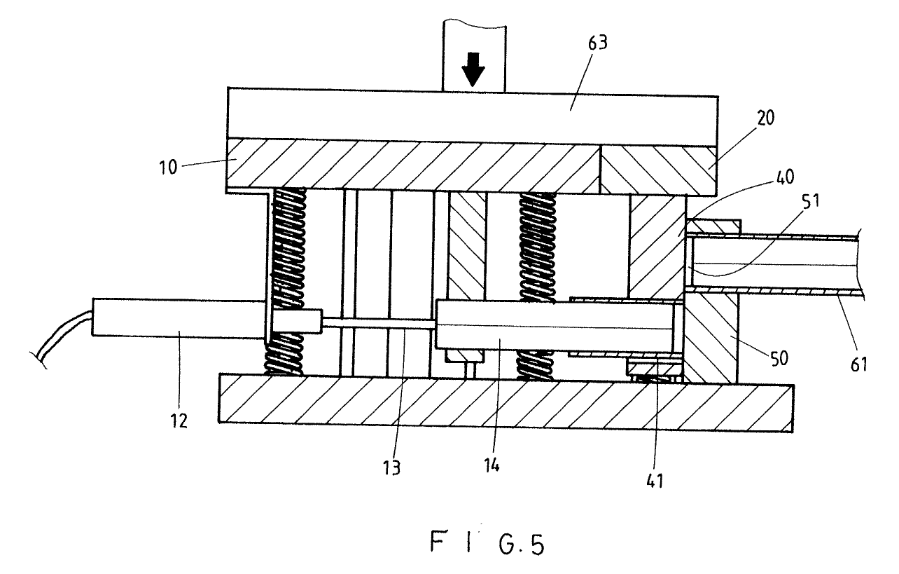

As shown in FIG. 4, a reciprocal activating press block (63) (as the reciprocal mechanism on a punching press) presses down on top surface of the upper mold unit (10) and the cutting mold unit (20). Since the top surface of the cutting mold unit (20) is higher than the top surface of the upper mold unit (10), and the upper edge of the cutting hole (41) of the first mold block (40) is higher than the upper edge of the through hole (51) of the second mold block (50), when the activating press block (63) presses downward, the cutting mold unit (20) can be pressed smoothly so there is a larger downward pressing force before the upper edge of the cutting hole (41) of the first mold block (40) contacting with the metal tube unit (61). And, when the upper edge of the cutting hole (41) contacted with the metal tube unit (61), the restricting function of the through hole (51) enables a mutually fixed status between the metal tube unit (61) and the cutting hole (41) and the through hole (51). As shown in FIG. 5, with continuous downward movement of the activating press block (63), the upper mold unit (10) and the cutting mold unit (20) move synchronously downward, so the relative positions without change between the extension press cylinder (12) on the upper mold unit (10), and the guide lever (14) at one end, and the first mold block (40). Therefore, when the first mold block (40) and the second mold block (50) move in relation to each other, there is a shearing force created between the cutting hole (41) and the through hole (51), which serves to cut the metal tube unit (61) inserted inside the cutting hole (41) and the through hole (51). Meanwhile, the guide lever (14) inserted inside the metal tube unit (61) has no effect by cutting action, but it provides support function to the metal tube unit (61) and prevents the metal tube unit (61) from being squeezed and deformed by the first mold block (40). After the extension end (13) of the extension cylinder (12) has retracted and the guide lever (14) has escaped from the metal tube unit (61), and when the activating press block (63) returned back to its original position, a section of metal tube of a specified length can be taken from the long metal tube unit (61)

Using the shearing force produced by the interacting movement of first mold block (40) and the second mold block (50), the metal tube unit (61) can be cut by the invention, requiring no careful operation of a sawing bench, without high-temperature red-hot waste iron scraps, this invention can perform cutting operation under high-speed relative movement, saving labor and time, preventing from bums and assuring high security. Meanwhile, since the metal tube unit (61) is cut by shearing force, there will be no excessive iron scraps, thereby reducing work burden of scraps handling process.

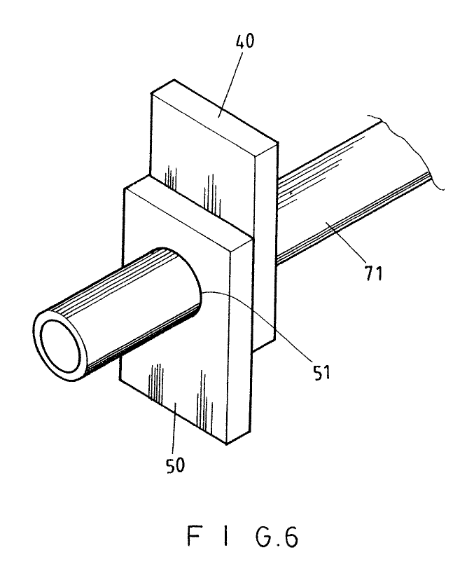

As shown in FIG. 6, by matching the cutting hole (41) (not shown in drawing) of the first mold block (40) and the through hole (51) of the second mold block (50) to a tube unit (71) of different section shapes, the tube unit (71) can be smoothly inserted in matching cutting hole (41) and through hole (51) and a specified length of tube unit (71) can be cut smoothly by the aforementioned reciprocal cutting operation. In case a cutting tool with a specified shape is used on the cutting mold, it requires replacement of the first and second mold blocks to cut tubes of different section shapes, which is obviously not so convenient. Therefore, this invention is not only sophisticated in its construction, but also more convenient and applicable in its operation.

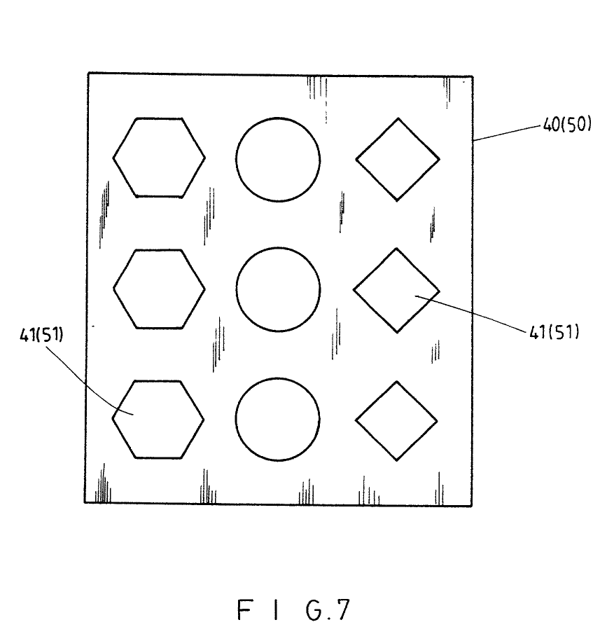

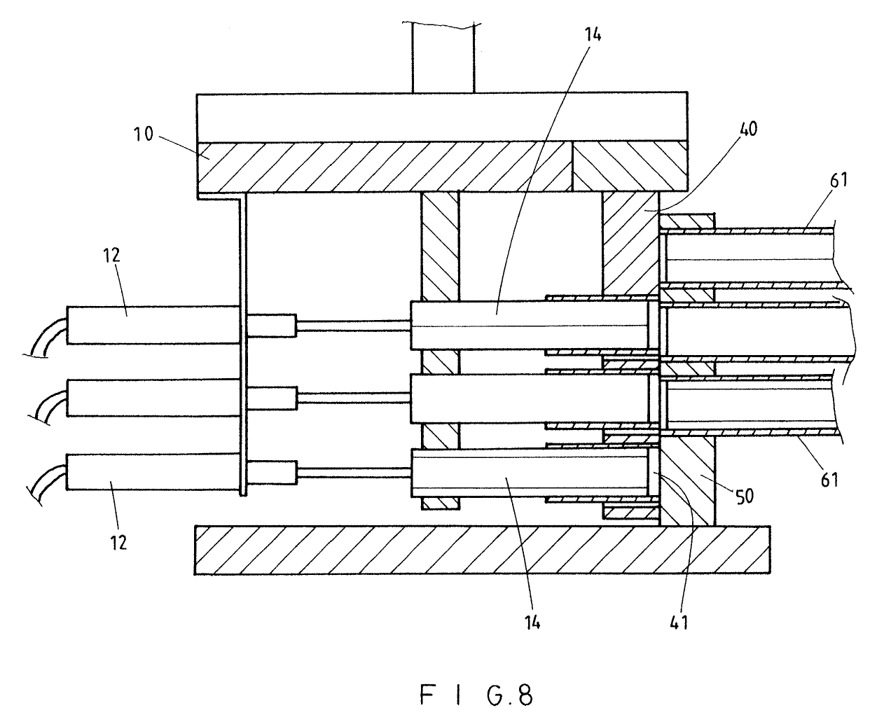

As shown in FIGS. 7 and 8 that illustrate another embodiment of the invention, wherein, there are more than one cutting hole (41) and through hole (51) on the first and second mold blocks (40), (50), in many shapes of different section shapes, and on one side of each extension cylinder (12) is fitted with a guide lever (14) to suit the shape of the cutting hole (41). In application, a metal tube unit (61) of a specified section shape is inserted in the cutting hole (41) and through hole (51) of a matching shape, to cut the metal tube unit (61) when the activating press block (63) presses down on the first mold block (40). In its application, much time can be saved on the process of cutting the metal tube unit (61), and much efficiency enhanced.

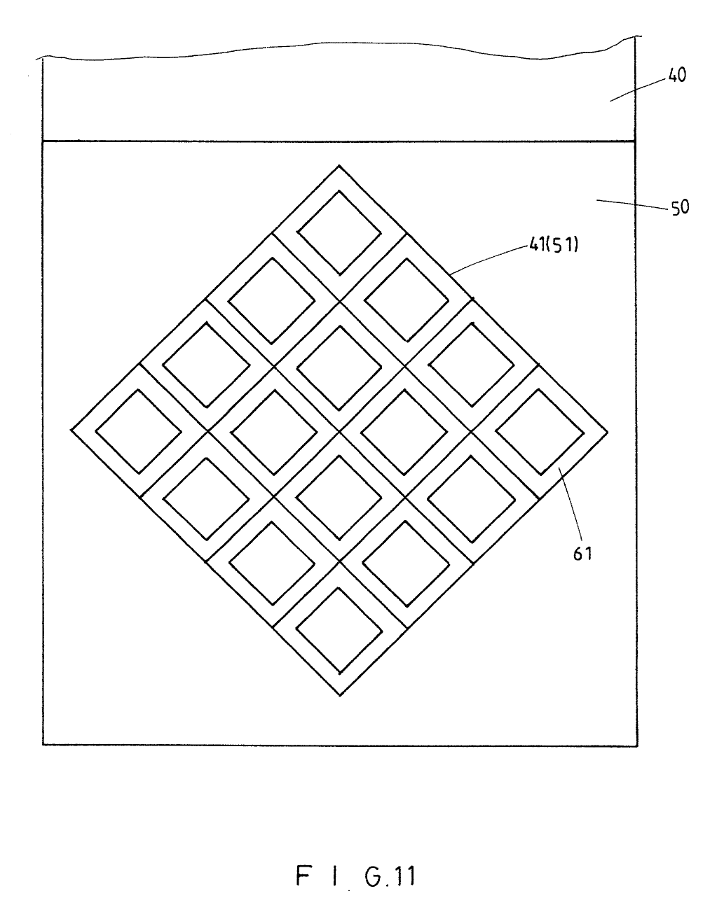

As shown in FIG. 11 that illustrates how several metal tube units (61) can be cut simultaneously, wherein, the area of the cutting hole (41) on the first mold block (40) and of the cutting hole (51) on the second mold block (50) is many times the section area of the metal tube unit. For example, the area of a square cutting hole (41) and square through hole (51) is designed to be four, nine or more folds of the section area of a square metal tube (61) (the side length of the cutting hole and through hole is a multiple of the side length of the metal tube unit), then a specified number of metal tube units (61) can be arranged inside matching cutting holes (41) and through holes (51), and by relative movement of the first mold block (40) and the second mold block (50), several metal tube units (61) can be cut, which will save cutting time and upgrading working efficiency.

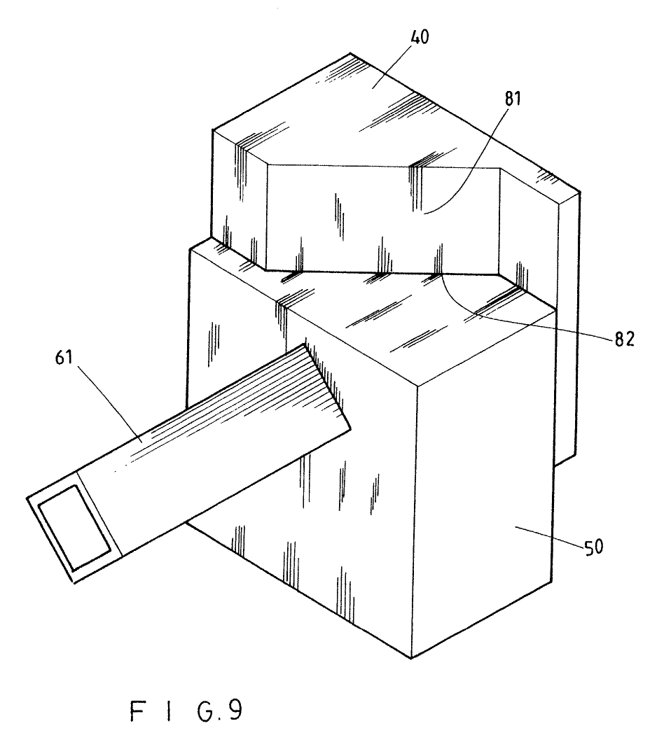

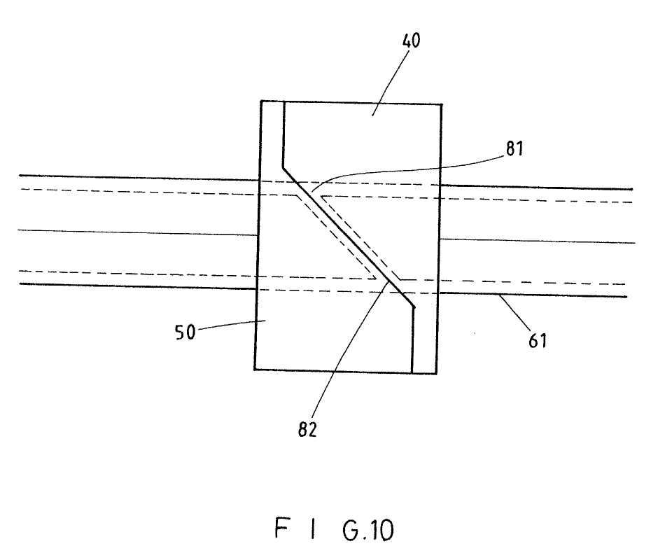

In working practice when metal tube units (61) are to be assembled as products, the tube joints of neighboring sections, lengthwise and crosswise, are often machines as oblique ends to facilitate assembly (such as window and door frames). So, to enable the metal tube units (61) cut by this invention to meet more extensive application requirements, the first mold block (40) and the second mold block (50) can be further modified, as shown in FIGS. 9 and 10, the matching sides of the first mold block (40) and the second mold block (50) can be machined to become inclines (81), (82) opposite each other. Meanwhile, the cutting hole (not shown in drawing) on the first mold block (40) and the through hole (51) on the second mold block (50) are connected when the inclines (81), (82) are matched. With the metal tube unit (61) inserted inside the first mold block (40) and the second mold block (50), when the first mold block (40) moves in relation to the second mold block (50), the metal tube unit (61) will be cut to have inclined ends to meet the requirement.

To conclude, in addition to its innovative and simplified construction, this invention is capable of achieving its anticipated objective of speedy and safe operation, upgrading operational safety and reducing waste iron scraps.

What is claimed is:

1. A cutting mold set of metal tubes comprising:
An upper mold unit, to which side being fixed withspecified number of extension press cylinders, a guide lever in a specified shape being installed on said the extension end of the extension press cylinder, to its bottom being assembled with several shaft rods and flexible members;
A cutting mold unit, to which bottom being assembled with several shaft rods, said cutting mold unit be installed on the opposite side of the extension press cylinder of the upper mold unit;
A lower mold unit, one of its surfaces being joined to one end of the shaft rods and flexible members which installed on the upper mold unit and the cutting mold unit, as well to have a relative movement with both the said upper mold unit and cutting mold unit;
A first mold block, on its surface being a running-through cutting hole in a specified shape, the said first mold block installed onto the bottom of the cutting mold unit;
A second mold block, on its surface being a through hole in a specified shape, the said second mold block installed onto the lower mold unit and next to the first mold block in its through hole being communicative with the cutting hole of said first mold block.

2. The cutting mold set of metal tubes as claimed in claim 1, wherein, said cutting mold unit is slightly higher than the upper mold unit after it is installed in position, and the upper edge of the cutting hole is slightly higher than the upper edge of the through hole of the second mold block.

3. The cutting mold set of metal tubes as claimed in claim 1, wherein, on the first mold block are several cutting holes in specified shapes, on the second mold block being several through holes in specified shapes to match the cutting holes of the said first mold block.

4. The cutting mold set of metal tubes as claimed in claim 1, wherein, the cutting holes area of the first mold block and the through holes area of the second mold block are multiple of the area of metal tube, so that a certain number of metal tubes can be arranged in position and cut simultaneously.

5. The cutting mold set of metal tubes as claimed in claim 1, wherein, the first mold block and the second mold block can respectively have inclines that match with each other, so the metal tube units have inclines at their ends after the metal tube units are cut by the relative movement of the first mold block and the second mold block.
